(19) United States
(12) Patent Application Publication
(10) Pub. No.: US 2020/0238501 A1
(43) Pub. Date: Jul. 30, 2020

(54) BOX FOR TOOLS AND COMPONENTS THEREOF

(71) Applicant: Jeffrey Baum, Kyle, TX (US)

(72) Inventor: Jeffrey Baum, Kyle, TX (US)

(21) Appl. No.: 16/750,581

(22) Filed: Jan. 23, 2020

Related U.S. Application Data
(60) Provisional application No. 62/821,045, filed on Mar. 20, 2019.
(60) Provisional application No. 62/796,257, filed on Jan. 24, 2019.

(51) Int. Cl. B25H 3/00

(52) U.S. Cl. CPC B25H 3/006; B25H 3/003

(57) ABSTRACT

A toolbox includes a main body and a lid. The main body has a base and a plurality of sidewalls. The sidewalls are disposed on and extend upwardly from the base. The sidewalls and the base together define an interior of the main body. Each of the sidewalls has an upper surface. The base has a plurality of socket holes formed therein. The socket holes are configured to receiving wrench sockets. The lid has an upper surface and a lower surface. The lid is slidably affixed to the sidewalls of the main body. The lid is selectively manually movable between a closed position, where the interior of the main body is covered, and an opened position, where the interior of the main body is uncovered. Each of the main body and the lid is formed entirely from a non-metallic material.

### CROSS-REFERENCE TO RELATED APPLICATIONS

This application claims the benefit of U.S. Provisional Application Ser. No. 62/821,045, filed on Mar. 28, 2019, and U.S. Provisional Application Ser. No. 62/796,257, filed on Jan. 24, 2019. The entire disclosures of the above applications are hereby incorporated herein by reference.

### FIELD

The present disclosure relates generally to a box for tools and components thereof and, more specifically, a toolbox for storing a multitude of wrench sockets and an associated wrench.

### BACKGROUND

Serious workers in the construction business usually require a toolbox, which may include a socket wrench consisting of a handle and of a plurality of detachable sockets of varied inner dimensions.

It happens, not infrequently, that these sockets are all put disorderly in a single pack within the toolbox, wherein selecting a desired one can be a lengthy procedure especially if the number of sockets is large. In fact, there is often involved, when selection of a given socket is desired, to identify, often empirically, which socket is the one that is required. This is not only inefficient, it is time-consuming, particularly where the sockets are in disarray. In this light, it would be beneficial to have an efficient and cost-effective means for organizing sockets and wrenches.

One known apparatus for holding socket wrench heads of different sizes is described in U.S. Pat. No. 5,080,230 to Winnard. The Winnard tool has a body member with a plurality of bores therethrough for receiving socket wrench heads, and also a flexible cover member with magnetic material embedded that is attached to the lower surface of the body member. Another toolbox for holding sockets is known and described in International Patent Application Publication No. WO1999022916 to Le Faou. The Le Faou toolbox has magnetic tool holders which are supported detachably on the upper part of a hollow box. Yet a further known toolbox is described in U.S. Pat. No. 6,868,967 to Lam. The Lam toolbox has a base, a lid, and at last one tray, and a metal strip attached to the bottom of each row of the base for magnetically holding the at least one tray.

It has been found that these known devices for storing or holding wrench sockets are undesirably inefficient, particularly in that ready access to the wrench sockets may be limited by the typical placement of these known devices into other toolboxes. These known devices also may involve magnetic materials or ferrous metals which are heavy and not cost-effective.

There is a continuing need for an efficient and cost-effective means for organizing wrench sockets and an associated wrench.

### SUMMARY

In concordance with the instant disclosure, an efficient and cost-effective means for organizing wrench sockets and an associated wrench, has surprisingly been discovered.

In one embodiment, a toolbox includes a main body and a lid. The main body has a base and a plurality of sidewalls. The sidewalls are disposed on and extend upwardly from the base. The sidewalls and the base together define an interior of the main body. Each of the sidewalls has an upper surface. The base has a plurality of socket holes formed therein. The socket holes are configured to receiving wrench sockets for storage and transport. The lid has an upper surface and a lower surface. The lid is slidably affixed to the sidewalls of the main body. The lid is selectively manually movable between a closed position and an opened position. The interior of the main body is covered where the lid is in the closed position. The interior of the main body is uncovered where the lid is in the opened position. Each of the main body and the lid is formed entirely from a non-metallic material such as polyurethane, as a particular example.

With respect to the main body, the plurality of sidewalls may include a first sidewall, a second sidewall, a third sidewall, and a fourth sidewall. The first sidewall is disposed opposite the second sidewall, and the third sidewall disposed opposite the fourth sidewall. Each of the third sidewall and the fourth sidewall connect the first sidewall and the second sidewall.

With respect to the lid, the lid may have a first side, a second side, a third side, and a fourth side. The first side of the lid may be disposed adjacent the first sidewall of the main body where the lid is in the closed position. The first side of the lid may also be disposed adjacent the second sidewall of the main body where the lid is in the opened position.

In another embodiment, the lower surface of the lid has a central rail, a third side rail, and a fourth side rail. The third side rail is disposed adjacent the third side of the lid. The fourth side rail is disposed adjacent the fourth side of the lid. The central rail is disposed between the third side rail and the fourth side rail. The second sidewall has a central channel formed in the upper surface of the second sidewall. The third sidewall has a third sidewall channel formed in the upper surface of the third sidewall. The fourth sidewall has a fourth sidewall channel formed in the upper surface of the fourth sidewall. The center channel of the second sidewall slidably receives the central rail of the lid. The third sidewall channel of the third sidewall slidably receives the third side rail of the lid. The fourth sidewall channel of the fourth sidewall slidably receives the fourth side rail of the lid.

In a further embodiment, the plurality of socket holes are arranged in a plurality of rows. In particular, the plurality of rows may include a first row, a second row, and a third row. The third row is disposed between the first row and the second row. The socket holes of the first row and the second row are arranged in series from largest diameter to smallest diameter. None of the socket holes in the third row have a diameter larger than the smallest diameter of the socket holes in the first row and the second row. The series of the second row is also ordered opposite the series of the first row.

In yet another embodiment, a wrench recess is formed in the base of the main body adjacent the plurality of socket holes. The wrench recess may have a first end with a first width and a second end with a second width. The second width is greater than the first width. The plurality of socket holes may also be formed in a single row disposed adjacent the wrench recess. The socket holes of the single row may be arranged in series from largest diameter to smallest diameter, with a one of the socket holes of the largest diameter disposed adjacent the first end of the wrench recess and the a one of the socket holes of the smallest diameter disposed adjacent the second end of the wrench recess.

### DRAWINGS

The above, as well as other advantages of the present disclosure, will become readily apparent to those skilled in the art from the following detailed description, particularly when considered in the light of the drawings described hereafter.

FIG. 1 is a top perspective view of a toolbox according to one embodiment of the present disclosure, the toolbox having a main body and lid and shown fully assembled with the lid in a closed and locked position;

FIG. 2 is a top perspective view of the toolbox shown in FIG. 1, and further illustrating the lid in an opened and locked position;

FIG. 3 is an exploded top perspective view of the toolbox shown in FIG. 1, and further illustrating rods on an underside of the lid and associated channels and hard stops on a top of the main body of the toolbox;

FIG. 4 is a bottom perspective view of the lid shown in FIGS. 1-3, and further illustrating the rods on the underside and raised tabs on one side of the lid for use in selectively locking with associated recesses on either side of the main body of the toolbox;

FIG. 5 is a top plan view of the toolbox shown in FIG. 1, and further illustrating a first embodiment where an interior of the main body only has holes for receiving wrench sockets;

FIG. 6 is a top plan view of the toolbox shown in FIG. 1, and further illustrating a second embodiment where the interior of the main body has both the holes for receiving wrench sockets and also a recess for receiving a wrench;

FIG. 7 is a cross-sectional side elevational view of the toolbox taken at section line A-A in FIG. 1, and further illustrating a middle rod abutting a hard stop formed in one side of the main body;

FIG. 8 is a cross-sectional side elevational view of the toolbox taken at section line B-B in FIG. 2, and further illustrating a locking recess of the lid engaged with one of the associated recesses on one side of the main body to hold the lid in the opened and locked position;

FIG. 9 is a top perspective view of the toolbox according to another embodiment of the present disclosure, and further illustrating a bottom container connectable with the main body of the toolbox;

FIG. 10 is an exploded side elevational view of the toolbox shown in FIG. 9;

FIG. 11 is a top plan view of the toolbox according to yet a further embodiment of the disclosure, and further showing a wrench socket tray molded directly into a main body of the toolbox; and

FIG. 12 is a top perspective view of the toolbox according to yet another embodiment of the present disclosure, and further showing a socket holder molded into a tray for placement in the main body of the toolbox.

### DETAILED DESCRIPTION

The following detailed description and appended drawings describe and illustrate various embodiments of the invention. The description and drawings serve to enable one skilled in the art to make and use the invention and are not intended to limit the scope of the invention in any manner.

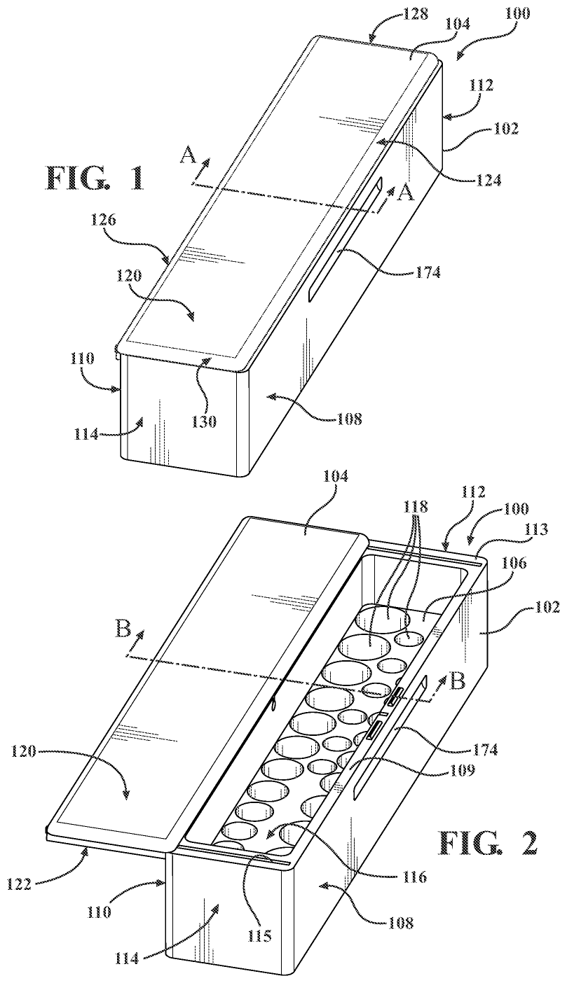

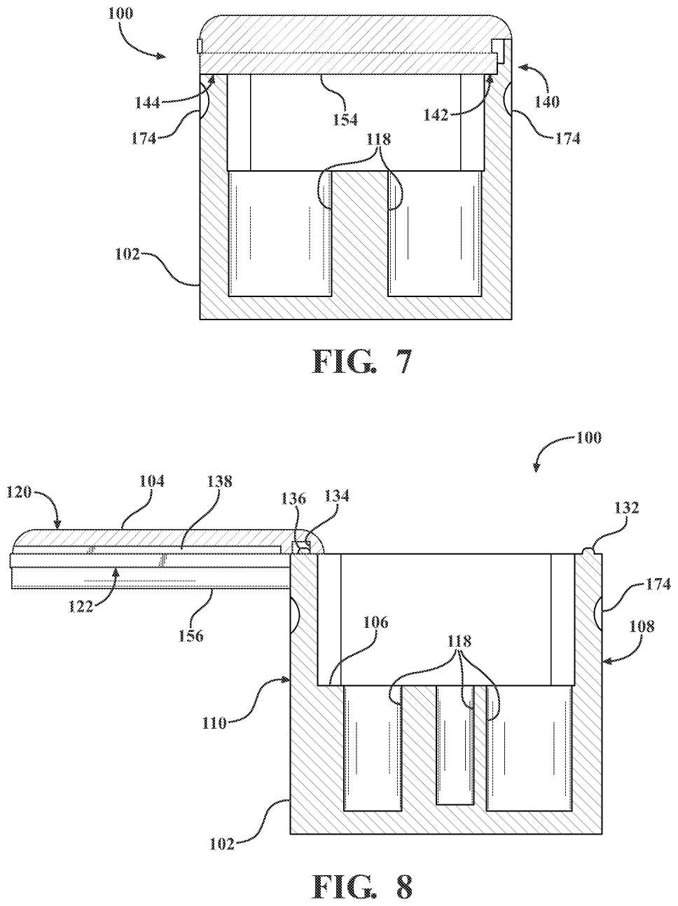

A toolbox 100 according to various embodiment of the disclosure is shown in FIGS. 1-12. In particular, the toolbox 100 is configured for securely storing and storing wrench sockets (not shown) and an associated wrench (not shown).

With reference to FIGS. 1-3, the toolbox 100 has a main body 102 and a lid 104. The lid 104 is slidably affixed to the main body 102 and is selectively movable between a closed position (shown in FIG. 1) and an opened position (shown in FIG. 2).

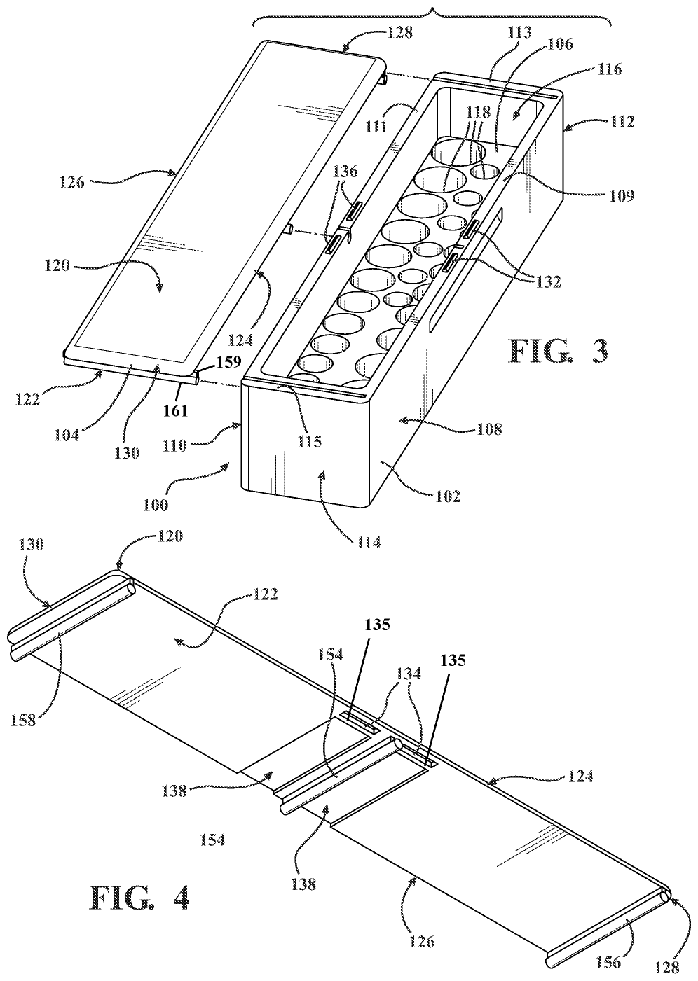

In certain examples, the main body 102 has a base 106 and a plurality of sidewalls 108, 110, 112, 114. Each of the sidewalls 108, 110, 112, 114 also has an associated upper surface 109, 111, 113, 115, as shown in FIGS. 2 and 3. The sidewalls 108, 110, 112, 114 are disposed on the base 106. For example, the sidewalls 108, 110, 112, 114 may be integrally formed with the base 106, or may be separately formed and then attached to the base 106.

In a most particular example, the base 106 and the sidewalls 108, 110, 112, 114 of the main body 102 are conformed by a molding operation involving a non-metallic material such as a polymeric or elastomeric material. As a non-limiting example, the polymeric or elastomeric material may be a polyurethane. Likewise, the lid 104 may be formed by a molding operation involving the same or different elastomeric material as the main body 102. It should also be appreciated that, in most particular examples, the main body 102 and the lid 104 are formed entirely of the non-metallic material and contains no magnets. One of ordinary skill in the art may also select other suitable materials for the main body 102 and the lid 104 of the toolbox 100, as desired.

It should be understood that polyurethane materials are believed to be especially advantageous for the toolbox 100 of the present disclosure. In particular, polyurethane rubber has been shown to be sufficiently durable and resistant to grime and oil. The flexibility of the polyurethane rubber also has bee shown to surprisingly grip and securely hold the wrench sockets in operation, as described further herein, repeatedly and reusably without significant wear or tearing and without the need for magnets that are costly and would otherwise add undesirably to the weight of the toolbox 100. The polyurethane rubber is also readily moldable, for example, by injection molding, rotational molding, or the like, which may be a preferred method of formation in this instance.

Regardless of the method of formation selected for the main body 102, the sidewalls 108, 110, 112, 114 extend upwardly from the base 106 and define with the base 106 an interior 116 of the main body 102. The interior 116 of the main body 102 is covered in its entirety where the lid 104 is in the closed position. The interior 116 of the main body 102 is uncovered in its entirety where the lid 104 is in the opened position.

As shown in FIGS. 2 and 3, the base 106 further has a plurality of socket holes 118 formed therein. The socket holes 118 are configured to securely receive wrench sockets in operation. For example, the socket holes 118 are sized to the precise diameters of conventional wrench sockets, so as to provide a friction fit for the wrench sockets where inserted into the socket holes 118. The friction fit secures the wrench sockets within the socket holes 118 so that the wrench sockets do not inadvertently fall from the socket holes 118 where the toolbox 100 is tipped or inverted, but yet permits the user to manually remove the wrench sockets easily by pulling the wrench sockets from the socket holes 118. Any suitable numbers of the socket holes 118 or numbers of rows of the socket holes 118 may be selected by the skilled artisan, as desired.

With reference to FIGS. 1-4, the lid 104 of the toolbox 100 has an upper surface 120 and a lower surface 122. The lid 104 is slidably affixed to the sidewalls 108, 110, 112, 114 of the main body 102. The lower surface 122 of the lid 104 may abut each of the upper surfaces 109, 111, 113, 115 of the sidewalls 108, 110, 112, 114 of the main body 102 where the lid 104 is placed in the closed position.

In particular, the plurality of sidewalls 108, 110, 112, 114 includes a first sidewall 108, a second sidewall 110, a third sidewall 112, and a fourth sidewall 114. The first sidewall 108 may be disposed opposite the second sidewall 110, and the third sidewall 112 may be disposed opposite the fourth sidewall 114, for example, as shown in FIG. 3. Likewise, each of the third sidewall 112 and the fourth sidewall 114 may connect the first sidewall 108 and the second sidewall 110, to thereby form a box-shape for the toolbox 100. However, although four (4) sidewalls and a box-shape is shown and described for purpose of illustrating the present disclosure, one skilled in the art may also select other suitable numbers of sidewalls and different suitable shapes for the toolbox 100, as desired.

Where the main body 102 of the toolbox 100 has the box-shape as described, the lid 104 may also have a first side 124, a second side 126, a third side 128, and a fourth side 130. In operation, the first side 124 of the lid 104 is disposed adjacent the first sidewall 108 of the main body 102 where the lid 104 is in the closed position (shown in FIG. 1). Also, in operation, the first side 124 of the lid 104 is disposed adjacent the second sidewall 110 of the main body 102 where the lid 104 is in the opened position (shown in FIG. 2).

Referring now to FIGS. 2-8. the first sidewall 108 of the main body 102 may have at least one first raised rib 132 formed in the upper surface 109 of the first sidewall 108. Likewise, and as particularly shown in FIG. 4, the lid 104 may have at least one locking recess 134 formed on the lower surface 122 of the lid 104 adjacent the first side 124 of the lid 104. The size and shape of the at least one first raised rib 132 corresponds with the size and shape of the at least one locking recess 134 such that the at least one first raised rib 132 is configured to be received by the at least one locking recess 134. In operation, the at least one first raised rib 132 is received by the locking recess 134 where the lid 104 is in the closed position.

With reference to FIG. 3, the second sidewall 110 of the main body 102 further may have at least one second raised rib 136. The at least one second raised rib 136 is formed in the upper surface 111 of the second sidewall 110. The size and shape of the at least one second raised rib 136 also corresponds with the size and shape of the at least one locking recess 134 such that the at least one second raised rib 136 is configured to be received by the at least one locking recess 134. In operation, the at least one second raised rib 136 is receive by the locking recess 134 where the lid 104 is in the opened position.

Although the at least one locking recess 134 and the associated at least one first raised rib 132 and the at least one second raised rib 136 are shown as being substantially rectangular in shape, one of ordinary skill in the art may select other suitable sizes and shapes for the at least one first raised rib 132, the at least one locking recess 134, and the at least one second raised rib 136 within the scope of the present disclosure.

In alternate embodiments contemplated, but not shown, it should be understood that the at least one locking recess 134 may be provided in the form of a raised rib, and the at least one first and second raised ribs 132, 136 may be provided in the form of a recess. Although the arrangement of the corresponding ribs and recesses in these alternate embodiments is opposite shown in FIGS. 2-8, it should be appreciated that the arrangement may function similarly and is therefore considered to be within the scope of the instant disclosure.

As shown in FIG. 4, the lid 104 in certain embodiments may further have at least one gripping portion 138. The gripping portion 138 is a channel formed in the lower side 122 of the lid 104 and configured to permit the user to manually grasp the gripping portion 138 where the lid 104 is in the closed position, and to pull the lid 104 from the closed position to the opened position. The at least one gripping portion 138 may be disposed adjacent the at least one locking recess 134, for example, and be separated by a wall 135. In particular, the at least one gripping portion 138 may be disposed between the at least one locking recess 134 and the second side 126 of the lid 104.

In operation, the at least one first raised rib 132 is configured to slide through the gripping portion 138 after being pulled over the intervening wall 135 between the gripping portion 138 and the at least one locking recess 134 as the lid 104 is moved to the opened position from the closed position. In this manner, the gripping portion 138 also serves as a guide for the at least one first raised rib 132 as the lid 104 is moved.

In particular embodiments, the at least one gripping portion 138 has a thickness that is less than a thickness of a surrounding major portion of the lid 104. This difference in relative thickness allows the at least one gripping portion 138 to be open to the second side 126 of the lid 104, for example, as shown in FIG. 4. This opening can be readily grasped by the user in operation where the lid 104 is otherwise in the closed position and permits the user to manually move the lid 104 from the closed position to the opened position for the insertion or removal of the wrench sockets.

With renewed reference to FIGS. 3 and 5-6, in certain embodiments the at least one first raised rib 132 includes a pair of first raised ribs 132, and the at least one second raised rib 136 includes a pair of second raised ribs 136. For example, the first and second raised ribs 132, 136 may be disposed on opposing sides of a lateral centerline of the main body 102.

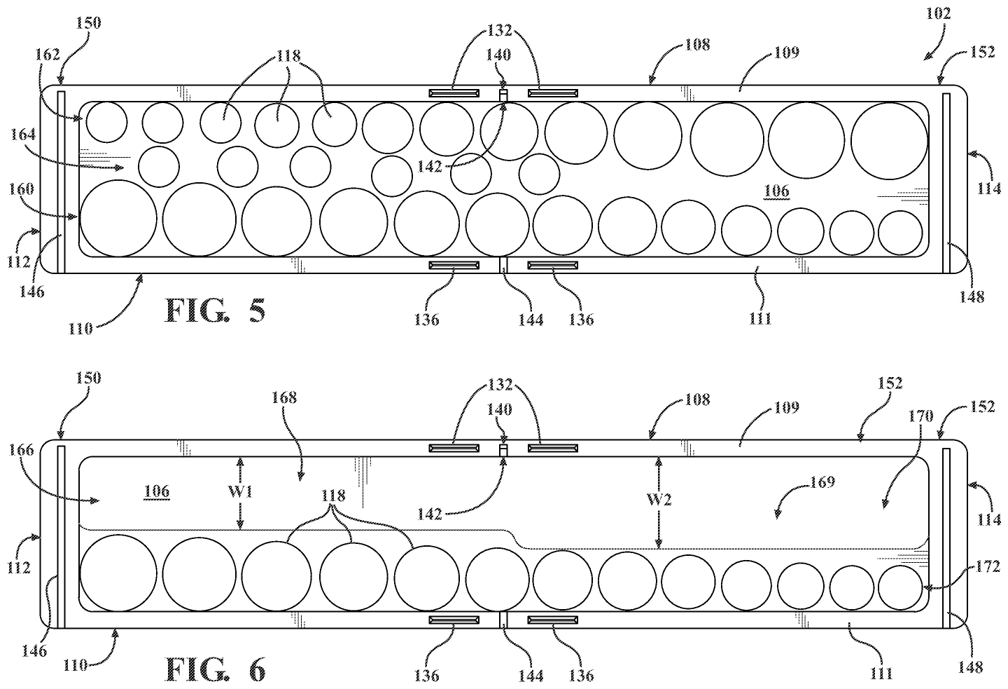

In further embodiments, as shown in FIGS. 5 and 6, a center hard stop 140 is formed in the first sidewall 108 between the pair of first raised ribs 132. The first sidewall 108 also has a niche 142 formed in the upper surface 109 of the first sidewall 108. The niche 142 is disposed between the center hard stop 140 of the first sidewall 108 and the interior 106 of the main body 102. A center channel 144 is also formed in the second sidewall 110 between the pair of second raised ribs 136. The center channel 144 is coaxial with the niche 142 and is disposed directly opposite the niche 142 across the interior 116, as also shown in FIGS. 5 and 6. Additionally, the third sidewall 112 may have a third sidewall channel 146 formed in the upper surface 113 of the third sidewall 112. The fourth sidewall 114 may have a fourth sidewall channel 148 formed in the upper surface 115 of the fourth sidewall 114.

With reference to FIG. 4, the lower surface 122 of the lid 104 has a central rail 154, a third side rail 156, and a fourth side rail 158. The third side rail 156 is disposed adjacent the third side 128 of the lid 104, and the fourth side rail 158 is disposed adjacent the fourth side 130 of the lid 104. The central rail 154 is disposed between the third side rail 156 and the fourth side rail 158, and more particularly is equally spaced apart from the third side rail 156 and the fourth side rail 158. It should also be appreciated that each of the central rail 154, the third side rail 156, and the fourth side rail 158 are oriented in parallel with one another.

In operation, the center channel 144 of the second sidewall 110 slidably receives the central rail 154 of the lid 104, the third sidewall channel 146 of the third sidewall 112 slidably receives the third side rail 156 of the lid 104, and the fourth sidewall channel 148 of the fourth sidewall 114 slidably receives the fourth side rail 158 of the lid 104. It should also be appreciated that the niche 142 of the first sidewall 108 also slidably receives the central rail 154 of the lid 104 where the lid 104 is in the closed position. Likewise, it should be appreciated that the niche 142 does not receive the central rail 154 of the lid 104 where the lid 104 is in the opened position. The central hard stop 140 is configured to militate against the lid 104 sliding past the closed position where the lid 104 is being manually moved from the opened position, by an abutting of the central rail 154 with the central hard stop 140.

In particular examples, as best shown in FIG. 3, the central rail 154, the third side rail 156, and the fourth side rail 158 are each comprised of a wall portion 159 extending outwardly from the lower surface 122 of the lid 104 and terminating at a cylinder 161 having a width greater than a width of the association wall portion 159. The size of the cylinder 161 may be selected to correspond with the shape of the corresponding one of the center channel 144, the third sidewall channel 146, and the fourth sidewall channel 148 that receives the associated one of the central rail 154, the third side rail 156, and the fourth side rail 158.

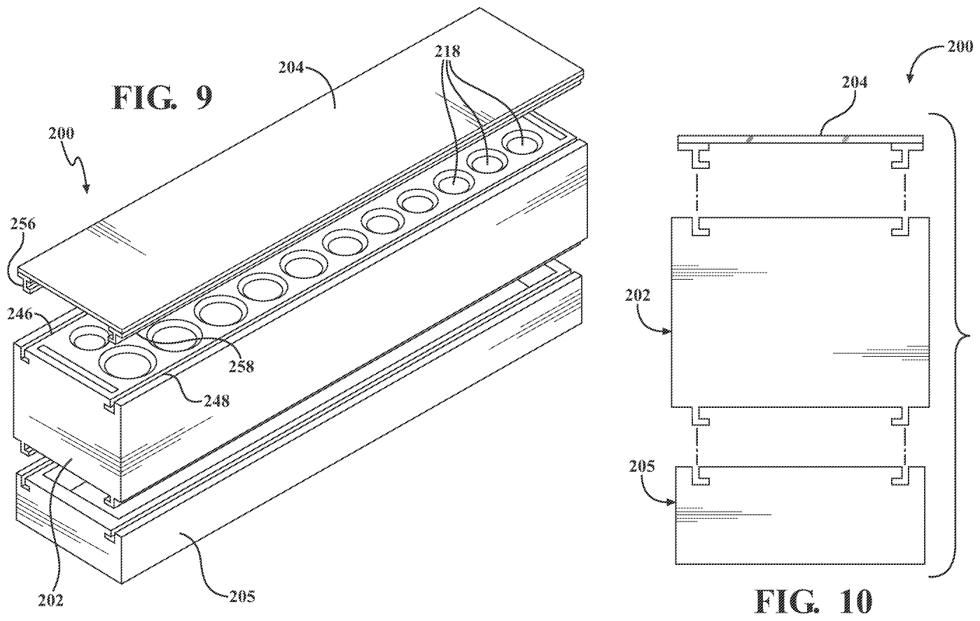

In other examples, as shown in FIGS. 9 and 10, at least one of the central rail 154 (not shown in FIGS. 9 and 10), the third side rail 156 (shown as 256), and the fourth side rail 158 (shown as 258) may be substantially L-shaped in cross-section. In such cases, the corresponding one of the center channel 144 (not shown), the third sidewall channel 146 (shown as 246), and the fourth sidewall channel 148 (shown as 248) that receives the associated one of the central rail 154, the third side rail 156, and the fourth side rail 158 may be provided with a corresponding shape and size. Other suitable shapes and sizes for the center channel 144, the third sidewall channel 146, and the fourth sidewall channel 148, and the associated one of the central rail 154, the third side rail 156, and the fourth side rail 158 may also be selected within the scope of the present disclosure.

It should also be appreciated that the orientations of the center channel 144, the third sidewall channel 146, and the fourth sidewall channel 148, and the associated one of the central rail 154, the third side rail 156, and the fourth side rail 158, may be selected by a skilled artisan within the scope of the disclosure. For example, as shown in FIGS. 1-8, the orientations may be transverse to a longitudinal axis of the toolbox 100. In another example, as shown in FIGS. 9-10, the orientations may be parallel with the longitudinal axis of the toolbox 100. Other suitable orientations may also be employed, as desired.

With renewed reference to FIGS. 5 and 6, the third sidewall 112 may also be provided with a third sidewall hard stop 150, and the fourth sidewall 114 may also be provided with a fourth sidewall hard stop 152. In such case, where the lid 104 is in the closed position, the third side rail 156 abuts the third sidewall hard stop 150 of the third sidewall 112, and the fourth side rail 158 abuts the fourth sidewall hard stop 152 of the fourth sidewall 114. It is believed that the addition of the third sidewall hard stop 150 and the fourth sidewall hard stop 152, in addition to the central hard stop 140, helps further militate against the lid 104 sliding past the closed position where the lid 104 is being manually moved from the opened position.

Although the central hard stop 140, the third sidewall hard stop 150, and the fourth sidewall hard stop 152 are shown and described herein, it should be appreciated that in other embodiments there are no hard stops 140, 150, 152. In such cases, the center channel 144, the third sidewall channel 146, and the fourth sidewall channel 148 instead extend a full length across the relevant sidewalls such that the lid 104 may be inserted from either side. Other suitable arrangements for the hard stops 140, 150, 152 and the channels 144, 146, 148 may also be employed, as desired.

As illustrated in FIG. 5, the plurality of socket holes 118 may be arranged in a plurality of rows 160, 162, 164 in the interior 116 of the toolbox 100. In particular, the plurality of rows 160, 162, 164 may include a first row 160, a second row 162, and a third row 164. The third row 164 may be disposed between the first row 160 and the second row 162. The socket holes 118 of the first row 160 and the second row 162 may further be arranged in series from largest diameter to smallest diameter, for example, as shown in FIG. 5. In a most particular embodiment, none of the socket holes 118 in the third row 164 have a diameter larger than the smallest diameter of the socket holes 118 in the first row 160 and the second row 162. Furthermore, the series of the second row 162 may be ordered opposite the series of the first row 160. It has been found that this arrangement and ordering of the size in the series of the plurality of rows 160, 162, 164 provides for a more efficient storage of the wrench sockets in operation.

As illustrated in FIG. 6, another embodiment of the toolbox 100 includes a wrench recess 170 formed in the base 116 of the main body 102 adjacent the plurality of socket holes 118. The wrench recess 170 may have a first end 168 with a first width W1 and a second end 169 with a second width W2. The plurality of socket holes 118 may be formed in a single row 172 disposed adjacent to the wrench recess 170. In particular examples, the second width W2 is greater than the first width W1 such that the wrench recess 170 is configured to receive and secure a typical socket wrench. Other suitable sizes and shapes for the wrench recess 170 may also be employed, as desired.

With continued reference to FIG. 6, the socket holes 118 of the single row 172 may be arranged in series from largest diameter to smallest diameter. In this example, one of the socket holes 118 of the largest diameter may be disposed adjacent the first end 168 of the wrench recess 170 and the a one of the socket holes 118 of the smallest diameter may be disposed adjacent the second end 169 of the wrench recess 170.

With renewed reference to FIGS. 1 and 7-8, the toolbox 100 of the present disclosure also be provided with at least one handle 174. For example, the handle 174 may be in the form of an elongate handle recess formed in an outer surface of the second sidewall 108 of the main body 102. In certain examples, the handle 174 may be in the form of an elongate handle recess formed in the outer surface of the first sidewall 106 of the main body 102. Other suitable types and locations for the handle 174 are contemplated and may also be employed within the scope of the present disclosure.

Yet other embodiments are shown in FIGS. 9 and 10, 11 and 12. In these embodiments, like or related structure to that shown in FIGS. 1-8 is identified with the same reference number in a 200-, 300-, or 400-series instead of a 100-series, for purpose of clarity.

In FIGS. 9 and 10, the toolbox 200 is shown having the main body 202 and the lid 204. In this case, the rails 256, 258 and the associated channels 246, 248 are oriented parallel with a longitudinal axis of the main body 102. Furthermore, the toolbox 200 may be provided with an additional connecting box 205, which may be selectively connected to an underside of the main body 102, for example, with rails or the like. Other suitable means for attaching the additional connecting box 205 to the main body may also be selected by a skilled artisan as desired and are considered to be within the scope of the instant disclosure.

In FIG. 11, the toolbox 300 is shown having the main body 302. The lid 304 in this case is hingedly attached to the main body 302. The socket holes 318 are integrally molded into the interior of the main body 302 in this case.

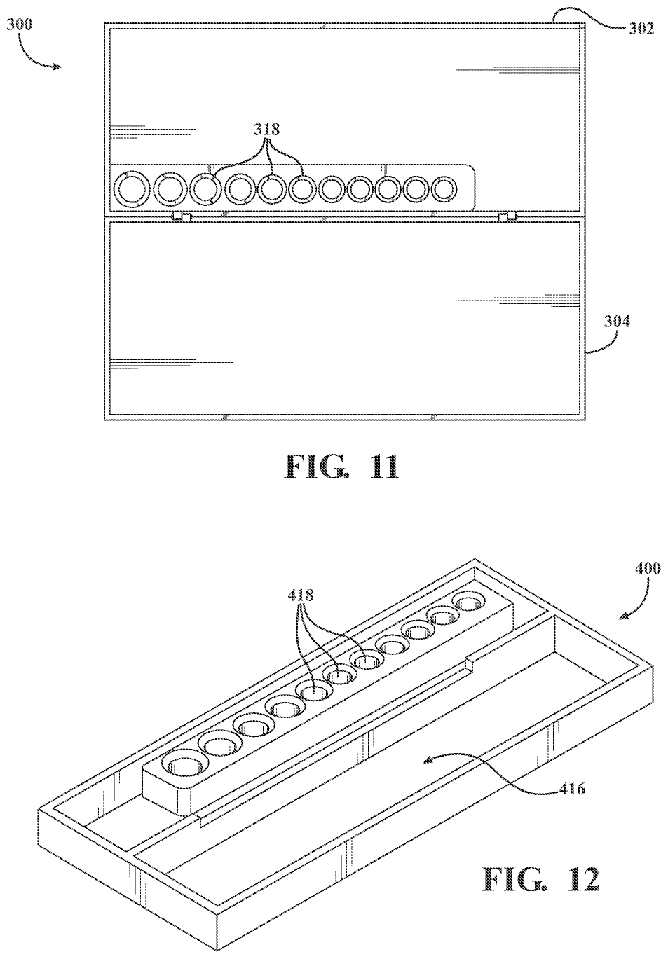

In FIG. 12, a removable insert 400 for the toolbox is shown having the socket holes 418 integrally molded in the interior of the removable insert 400.

Advantageously, the toolbox 100, 200, 300. 400 of the present disclosure has been found to be an efficient and cost-effective means for organizing wrench sockets and an associated wrench.

While certain representative embodiments and details have been shown for purposes of illustrating the invention, it will be apparent to those skilled in the art that various changes may be made without departing from the scope of the disclosure, which is further described in the following appended claims.

What is claimed is:

1. A toolbox, comprising;
a main body having a base and a plurality of sidewalls, the sidewalls disposed on and extending upwardly from the base and defining with the base an interior of the main body, each of the sidewalls having an upper surface, and the base having a plurality of socket holes formed therein, the socket holes configured to receiving wrench sockets; and
a lid having an upper surface and a lower surface, the lid slidably affixed to the sidewalls of the main body, the lid selectively manually movable between a closed position where the interior of the main body is covered and an opened position where the interior of the main body is uncovered,
wherein each of the main body and the lid is formed entirely from a non-metallic material.

2. The toolbox of claim 1, wherein the plurality of sidewalls includes a first sidewall, a second sidewall, a third sidewall, and a fourth sidewall, the first sidewall disposed opposite the second sidewall, and the third sidewall disposed opposite the fourth sidewall, and each of the third sidewall and the fourth sidewall connecting the first sidewall and the second sidewall, and wherein the lid has a first side, a second side, a third side, and a fourth side, and wherein the first side of the lid is disposed adjacent the first sidewall of the main body where the lid is in the closed position and the first side of the lid is disposed adjacent the second sidewall of the main body where the lid is in the opened position.

3. The toolbox of claim 2, wherein the first sidewall of the main body has at least one first raised rib formed in the upper surface of the first sidewall, and the lid has at least one locking recess formed on the lower surface of the lid adjacent the first side of the lid, the locking recess receiving the at least one first raised rib where the lid is in the closed position.

4. The toolbox of claim 3, wherein the second sidewall of the main body at least one second raised rib formed in the upper surface of the second sidewall, the locking recess receiving the at least one second raised rib where the lid is in the opened position.

5. The toolbox of claim 5, wherein the lid further has at least one gripping portion disposed adjacent the at least one locking recess, the at least one gripping portion having a thickness that is less than a thickness of a major portion of the lid, the at least one gripping portion being open to the second side of the lid, and whereby the gripping portion permits the user to manually grasp the gripping portion where in the closed position and pull the lid from the closed position to the opened position.

6. The toolbox of claim 5, wherein the at least one first raised rib includes a pair of first raised ribs, and the at least one second raised rib includes a pair of second raised ribs, and a center hard stop is formed in the first sidewall between the pair of first raised ribs and center channel is formed in the second sidewall between the pair of second raised ribs.

7. The toolbox of claim 6, wherein the lower surface of the lid has a central rail, a third side rail, and a fourth side rail, the third side rail disposed adjacent the third side of the lid, the fourth side rail disposed adjacent the fourth side of the lid, and the central rail disposed between the third side rail and the fourth side rail.

8. The toolbox of claim 7, wherein the third sidewall has a third sidewall channel formed in the upper surface of the third sidewall, and the fourth sidewall has a fourth sidewall channel formed in the upper surface of the fourth sidewall, the center channel of the second sidewall slidably receiving the central rail of the lid, the third sidewall channel of the third sidewall slidably receiving the third side rail of the lid, and the fourth sidewall channel of the fourth sidewall slidably receiving the fourth side rail of the lid.

9. The toolbox of claim 8, wherein the first sidewall has a niche formed in the upper surface of the first sidewall, the niche disposed between the hard stop of the first sidewall and the interior of main body, the niche receiving the central rail of the lid where in the closed position and not receiving the central rail of the lid where in the opened position.

10. The toolbox of claim 9, wherein the third sidewall has a third sidewall hard stop and the fourth sidewall has a fourth sidewall hard stop, and where the lid is in the closed position the central rail abuts the center hard stop of the first sidewall, the third side rail abuts the third sidewall hard stop of the third sidewall, and the fourth side rail abuts the fourth sidewall hard stop.

11. The toolbox of claim 1, wherein the non-metallic material is a polyurethane.

12. The toolbox of claim 1, wherein the plurality of socket holes are arranged in a plurality of rows, the plurality of rows including a first row, a second row, and a third row, the third row disposed between the first row and the second row, the socket holes of the first row and the second row arranged in series from largest diameter to smallest diameter, and none of the socket holes in the third row have a diameter larger than the smallest diameter of the socket holes in the first row and the second row.

13. The toolbox of claim 12, wherein the series of the second row is ordered opposite the series of the first row.

14. The toolbox of claim 1, further comprising a wrench recess formed in the base of the main body adjacent the plurality of socket holes.

15. The toolbox of claim 14, wherein the wrench recess has a first end with a first width and a second end with a second width, and the second width is greater than the first width.

16. The toolbox of claim 15, wherein the plurality of socket holes are formed in a single row disposed adjacent the wrench recess.

17. The toolbox of claim 16, wherein the socket holes of the single row are arranged in series from largest diameter to smallest diameter, with a one of the socket holes of the largest diameter disposed adjacent the first end of the wrench recess and the a one of the socket holes of the smallest diameter disposed adjacent the second end of the wrench recess.

18. The toolbox of claim 1, further comprising an elongate handle recess formed in an outer surface of the second sidewall of the main body.

19. A toolbox, comprising;
a main body having a base and a plurality of sidewalls, the sidewalls disposed on and extending upwardly from the base and defining with the base an interior of the main body, each of the sidewalls having an upper surface, and the base having a plurality of socket holes formed therein, the socket holes configured to receiving wrench sockets, wherein the plurality of sidewalls includes a first sidewall, a second sidewall, a third sidewall, and a fourth sidewall, the first sidewall disposed opposite the second sidewall, and the third sidewall disposed opposite the fourth sidewall, and each of the third sidewall and the fourth sidewall connecting the first sidewall and the second sidewall; and
a lid having an upper surface and a lower surface, the lid slidably affixed to the sidewalls of the main body, the lid selectively manually movable between a closed position where the interior of the main body is covered and an opened position where the interior of the main body is uncovered, and wherein the lid has a first side, a second side, a third side, and a fourth side, and the first side of the lid is disposed adjacent the first sidewall of the main body where the lid is in the closed position and the first side of the lid is disposed adjacent the second sidewall of the main body where the lid is in the opened position, and
wherein the plurality of socket holes are arranged in a plurality of rows, the plurality of rows including a first row, a second row, and a third row, the third row disposed between the first row and the second row, the socket holes of the first row and the second row arranged in series from largest diameter to smallest diameter, and none of the socket holes in the third row have a diameter larger than the smallest diameter of the socket holes in the first row and the second row,
wherein the series of the second row is ordered opposite the series of the first row,
wherein the lower surface of the lid has a central rail, a third side rail, and a fourth side rail, the third side rail disposed adjacent the third side of the lid, the fourth side rail disposed adjacent the fourth side of the lid, and the central rail disposed between the third side rail and the fourth side rail,
wherein the second sidewall has a central channel formed in the upper surface of the second sidewall, the third sidewall has a third sidewall channel formed in the upper surface of the third sidewall, and the fourth sidewall has a fourth sidewall channel formed in the upper surface of the fourth sidewall, the center channel of the second sidewall slidably receiving the central rail of the lid, the third sidewall channel of the third sidewall slidably receiving the third side rail of the lid, and the fourth sidewall channel of the fourth sidewall slidably receiving the fourth side rail of the lid, and
wherein each of the main body and the lid is formed entirely from a polymeric material.

20. A toolbox, comprising;
a main body having a base and a plurality of sidewalls, the sidewalls disposed on and extending upwardly from the base and defining with the base an interior of the main body, each of the sidewalls having an upper surface, and the base having a plurality of socket holes formed therein, the socket holes configured to receiving wrench sockets, wherein the plurality of sidewalls includes a first sidewall, a second sidewall, a third sidewall, and a fourth sidewall, the first sidewall disposed opposite the second sidewall, and the third sidewall disposed opposite the fourth sidewall, and each of the third sidewall and the fourth sidewall connecting the first sidewall and the second sidewall, and further including a wrench recess formed in the base of the main body adjacent the plurality of socket holes; and
a lid having an upper surface and a lower surface, the lid slidably affixed to the sidewalls of the main body, the lid selectively manually movable between a closed position where the interior of the main body is covered and an opened position where the interior of the main body is uncovered, and wherein the lid has a first side, a second side, a third side, and a fourth side, and the first side of the lid is disposed adjacent the first sidewall of the main body where the lid is in the closed position and the first side of the lid is disposed adjacent the second sidewall of the main body where the lid is in the opened position,
wherein the wrench recess has a first end with a first width and a second end with a second width, and the second width is greater than the first width,
wherein the plurality of socket holes are formed in a single row disposed adjacent the wrench recess,
wherein the socket holes of the single row are arranged in series from largest diameter to smallest diameter, with a one of the socket holes of the largest diameter disposed adjacent the first end of the wrench recess and the a one of the socket holes of the smallest diameter disposed adjacent the second end of the wrench recess,
wherein the lower surface of the lid has a central rail, a third side rail, and a fourth side rail, the third side rail disposed adjacent the third side of the lid, the fourth side rail disposed adjacent the fourth side of the lid, and the central rail disposed between the third side rail and the fourth side rail,
wherein the second sidewall has a central channel formed in the upper surface of the second sidewall, the third sidewall has a third sidewall channel formed in the upper surface of the third sidewall, and the fourth sidewall has a fourth sidewall channel formed in the upper surface of the fourth sidewall, the center channel of the second sidewall slidably receiving the central rail of the lid, the third sidewall channel of the third sidewall slidably receiving the third side rail of the lid, and the fourth sidewall channel of the fourth sidewall slidably receiving the fourth side rail of the lid, and
wherein each of the main body and the lid is formed entirely from a polymeric material.
